(19) United States
(12) Patent Application Publication
(10) Pub. No.: US 2024/0378853 A1
(43) Pub. Date: Nov. 14, 2024

(54) PRESENTING STATISTICS INFORMATION ON GARMENTS BY GROUPING MAIN FEATURES OF EACH GARMENT INTO PRIMARY FEATURES

(71) Applicant: CLO Virtual Fashion Inc., Seoul (KR)

(72) Inventors: Seung Woo OH, Seoul (KR); Jieun LEE, Seoul (KR); Donghyun KIM, Seoul (KR); Sumin LEE, Seoul (KR); Piljoong JEONG, Seoul (KR)

(21) Appl. No.: 18/619,184

(22) Filed: Mar. 28, 2024

(30) Foreign Application Priority Data
May 12, 2023 (KR) 10-2023-0061797
Aug. 25, 2023 (KR) 10-2023-0111962

(51) Int. Cl. G06V 10/75; G06V 10/44; G06V 10/54; G06V 10/56; G06V 10/74

(52) U.S. Cl. CPC G06V 10/758; G06V 10/44; G06V 10/54; G06V 10/56; G06V 10/761

(57) ABSTRACT

A three-dimensional (3D) garment content statistics information is generated by receiving features of each of a plurality of pieces of 3D garment data, determining a main feature for each of the plurality of pieces of 3D garment data based on the features, grouping main features of the plurality of pieces of 3D garment data into a plurality of groups based on a predetermined feature grouping scheme, determining one of main features included in each of the plurality of groups to be a primary feature of a corresponding group, and providing statistics related to the plurality of pieces of 3D garment data based on primary features of the plurality of groups.

### CROSS-REFERENCE TO RELATED APPLICATIONS

This application claims the benefit of Republic of Korea Patent Application No. 10-2023-0061797 filed on May 12, 2023, and Republic of Korea Patent Application No. 10-2023-0111962 filed on Aug. 25, 2023, in the Korean Intellectual Property Office, the entire disclosures of which are incorporated herein by reference for all purposes.

### BACKGROUND

### 1. Field of the Invention

Embodiments relate to processing information on garments to generate statistics information and interactively presenting the statistics information on the garments.

### 2. Description of the Related Art

Garments may have various features depending on the characteristics of the fabric. These characteristics encompass aspects such as colors, physical composition of the fabric, and its texture Garments may be expressed in various forms depending on the characteristics of the fabric and styles. The trends of garments change over time and region. Although these trends are important for designing, developing, and marketing new garments, it is often difficult to understand and summarize in an analytic manner since the features of garments associated with the trends are generally parameterized. Further, statistics information on these trends and features is not easy to obtain, adding difficulty in assessing or predicting trends of garments.

### SUMMARY

Embodiments relate to providing statistics information of garments where main features of a category for the garments are extracted by analyzing stored information on the garments. Each of the main features represents a predominant feature of the category in each of the garments. The main features of the garments are assigned to groups where each of the groups is associated with a primary feature of the category that is shared across garments in each of the groups. The information on the garments is processed according to the groups to generate statistics information on primary features. The generated statistics information including identifications of the primary features is presented.

In one or more embodiments, the garments for extracting the main features according to one or more criteria are selected from stored garments.

In one or more embodiments, the one or more criteria includes at least one of time periods of designing the garments, identifications of designers of the garments, and keywords.

In one or more embodiments, the main features of the garments are assigned by determining a reference value for each of the groups. The reference value indicates a standard or common feature. The similarity of the main features and reference values of the groups are determined. The main features are assigned to the groups according to the determined similarity.

In one or more embodiments, the generated statistics information includes ratios of the primary features occupied in the garments.

In one or more embodiments, the category is one of colors, textures of fabric, garment styles, or glyphs on the garments.

In one or more embodiments, after the selection of one of the primary features is received, statistics information on the main features assigned to a group corresponding to the selected primary feature is presented.

In one or more embodiments, the presented statistics information on the main features includes ratios of at least a subset of the main features assigned to the group.

In one or more embodiments, mood keywords corresponding to the primary features are presented.

In one or more embodiments, mapping between features of the category and mood keywords is stored. The mood keywords to be presented are determined according to the stored mapping.

Additional aspects of example embodiments will be set forth in part in the description which follows and, in part, will be apparent from the description, or may be learned by practice of the disclosure.

### BRIEF DESCRIPTION OF THE DRAWINGS

These and other aspects, features, and advantages of the invention will become apparent from the following description of example embodiments, taken in conjunction with the accompanying drawings of which:

FIG. 1 is a flowchart illustrating a method of providing statistics information on garments, according to an embodiment.

FIG. 2 is a conceptual diagram illustrating the grouping of main features of garments into primary features, according to an embodiment.

FIG. 3 is a diagram illustrating a user interface screen displaying pattern data of a three-dimensional (3D) garment, according to an embodiment.

FIGS. 4A to 6 are diagrams illustrating user interface screens for providing statistics information on 3D garments, according to an embodiment.

FIGS. 7A and 7B are diagrams illustrating practical color coordinate system (PCCS) tone mapping, according to an embodiment.

FIG. 8 is a diagram illustrating a hue, saturation, value (HSV) coordinate system according to an embodiment.

FIGS. 9A through 9E are diagrams illustrating user interface screens for providing statistics information associated with mood keywords, according to an embodiment.

FIG. 10 is a block diagram of an electronic device according to an embodiment.

### DETAILED DESCRIPTION

The following structural or functional descriptions of embodiments are merely intended for the purpose of describing the examples and the examples may be implemented in various forms. Accordingly, the embodiments are not to be construed as limited to the disclosure and should be understood to include all changes, equivalents, or replacements within the idea and the technical scope of the disclosure.

Although terms, such as first, second, and the like are used to describe various components, the components are not limited to the terms. These terms should be used only to distinguish one component from another component. For example, a first component may be referred to as a second component and similarly the second component may also be referred to as the first component.

It should be noted that, if one component is described as being “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components or combinations thereof, but do not preclude the presence or addition of one or more other features, integers, steps, operations, elements, components or combinations thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

A feature described herein refers to a characteristic or a trait of a garment. The feature may include, among others, color, types of fabric and styles of a garment. The features of a garment may be classified into multiple categories. Such categories include, for example, a color category, a fabric type category and a style category. A garment may be associated with multiple features of the same category. For example, a garment may include a front/back pattern of a blue color and sleeves of a red color. In such case, the garment's features of the color category include both blue and red colors.

A main feature described herein refers to a predominant feature of a category in a single garment. For example, when a garment is predominantly of blue color, the main feature of the garment associated with the color category is blue. Taking an example of a feature category of glyphs, the glyph that appears most often or the glyph that takes up the most surface area on the garment may be deemed to be the main feature of the garment.

A primary feature described herein refers to a representative feature extracted from a group of garments that share a feature of a category. For example, if a set of garments with pastel-toned colors are grouped together, the most often occurring color or the color (e.g., pink) that takes up the most surface area in the entire set of garments may be deemed as the primary feature in the group of garments.

A mood keyword described herein refers to a term or phrase that describes the emotional or atmospheric quality associated with a certain color. Colors often evoke specific and certain moods. Mood keywords are associated with different colors and are used to describe emotional or psychological impact of these colors. For example, a mood keyword associated with red color may be “passionate” or “energetic” while a mood keyword associated with blue color may be “calm” or “serene.”

Hereinafter, embodiments will be described in detail with reference to the accompanying drawings. When describing the embodiments with reference to the accompanying drawings, like reference numerals refer to like elements and a repeated description related thereto will be omitted.

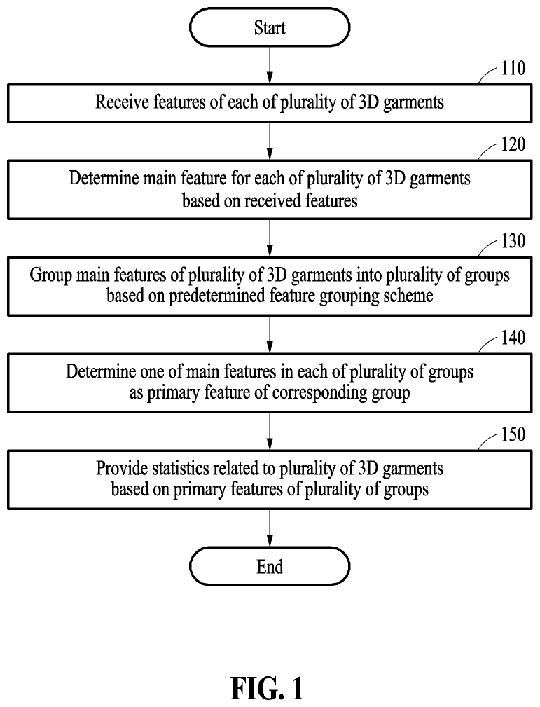

FIG. 1 is a flowchart illustrating a method of providing statistics information on garments, according to an embodiment. Although operations of FIG. 1 may be performed in the illustrated order and manner illustrated therein, the order of some of the operations may change or some of the operations may be omitted, without departing from the spirit and scope of the illustrated embodiment. Further, some of the operations shown in FIG. 1 may be performed in parallel or simultaneously.

Referring to FIG. 1, a processor 1030 may group features of various three-dimensional (3D) garments and provide statistics information related to the 3D garments from the grouped features. In operation 110, the processor 1030 may receive features of each 3D garment. These features may be stored in the form of garment data in memory of a computing device. The garment data may indicate patterns that make up the garment, their identification information, and characteristics of these patterns (e.g., colors, styles, types of texture, and glyphs on the pattern). Data for a subset of 3D garments to be analyzed for statistics information may be received by the processor 1030. The subset of 3D garments may be target garments for analysis, and may include, for example, garments recently designed or developed (e.g., designed within a year), designed within a certain time frame, categorized for a specific season (e.g., summer or winter) or designed by one or more specific designers.

A 3D garment may include, among others, a virtual garment that fits a user's body measurements, and a virtual garment that is worn on a 3D virtual character or avatar. The 3D garment may be represented as digitized data including information that enables a real-world garment to be manufactured and made available on a marketplace.

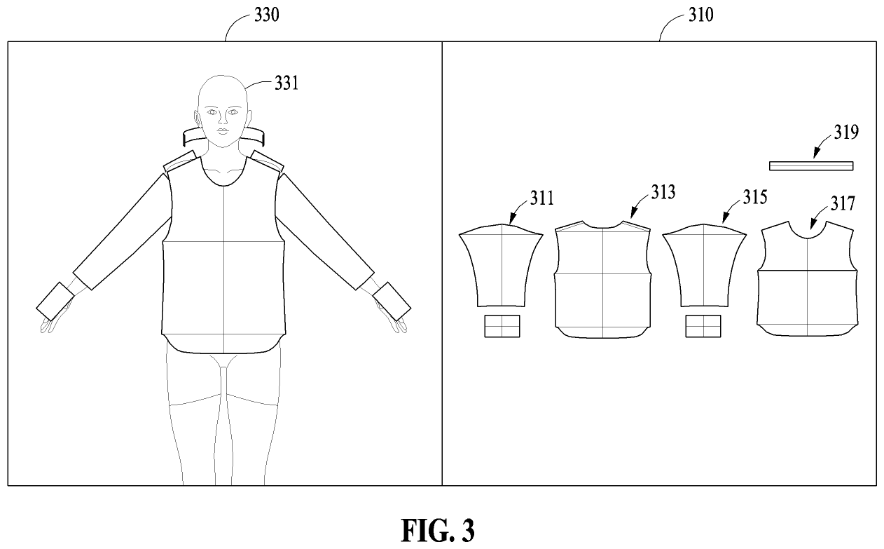

In operation 120, the processor 1030 may determine a main feature for each 3D garment from the features of the 3D garment. According to an embodiment, the processor 1030 may determine a main feature based on types of fabrics, colors, glyphs or other characteristics that occupy one or more patterns on a garment relative to the total surface area of the one or more patterns of the same garment. As described below in detail with reference to FIG. 3, a 3D garment may be composed of 2D pattern pieces 311, 313, 315, 317, 319 as displayed in a 2D pattern region 310. The processor 1030 may determine a ratio that certain features occupy collectively in the pattern pieces 311, 313, 315, 317, 319 of the 3D garment. The features may be associated with different categories such as types of fabrics, colors, and glyphs. For a specific category, a feature (e.g., blue color or polyester fabric) that takes up the most area on all of the pattern pieces 311, 313, 315, 317, 319 of a garment or repeated most frequently on the garment may be determined as the garment's main feature for that category (e.g., color category or fabric type category).

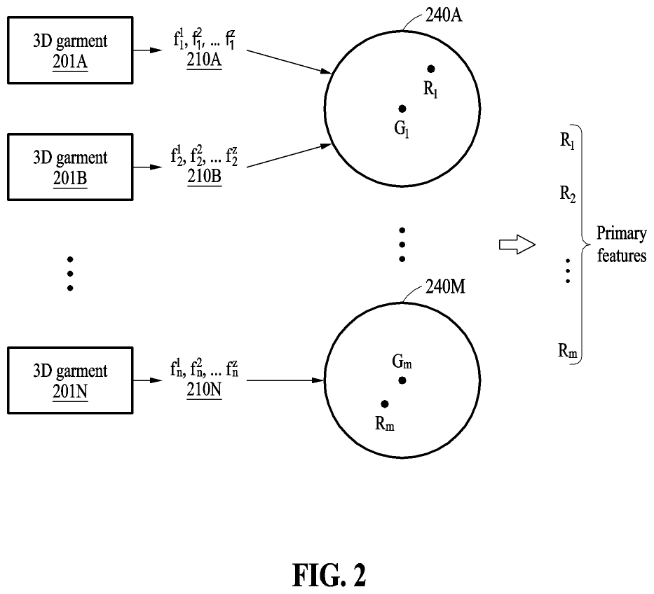

In operation 130, the processor 1030 may classify main features of multiple 3D garments into a plurality of groups based on a predetermined feature grouping scheme. The scheme of grouping main features into a plurality of groups is described below in detail with reference to FIG. 2.

In operation 140, the processor 1030 may determine one of main features included in each of the plurality of groups as a primary feature of a corresponding group. Reference values of the plurality of groups according to the predetermined feature grouping scheme may be different from primary features. A reference value indicates a standard feature as generally perceived in an industry or model. Taking an example of color, a reference value for the feature of pure blue color would be (0, 0, 255) under the RGB model, (240, 100, 100) under the HSV model or (0.150, 0.060) under a practical color coordinate system (PCCS).

On the other hand, a primary feature of a color (e.g., red) in a group of garments is determined according to the frequency or predominance of various colors that appear in the group of garments. The frequency of main features across a plurality of 3D garments may indicate how often these main features are actually used across the plurality of 3D garments. Taking the example of a color category, a reference value of a group is a color coordinate of a commonly used color or standard color (e.g., pure red). On the other hand, a color that is frequently or predominantly used in garments of a group is set as the primary color of the group.

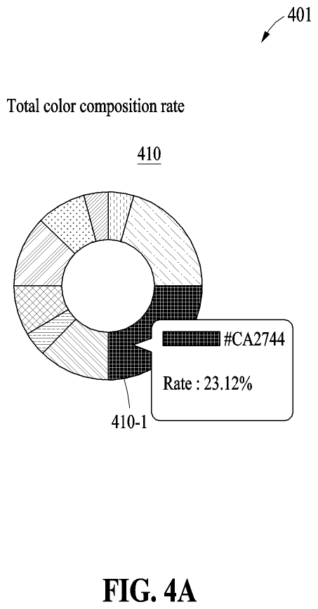

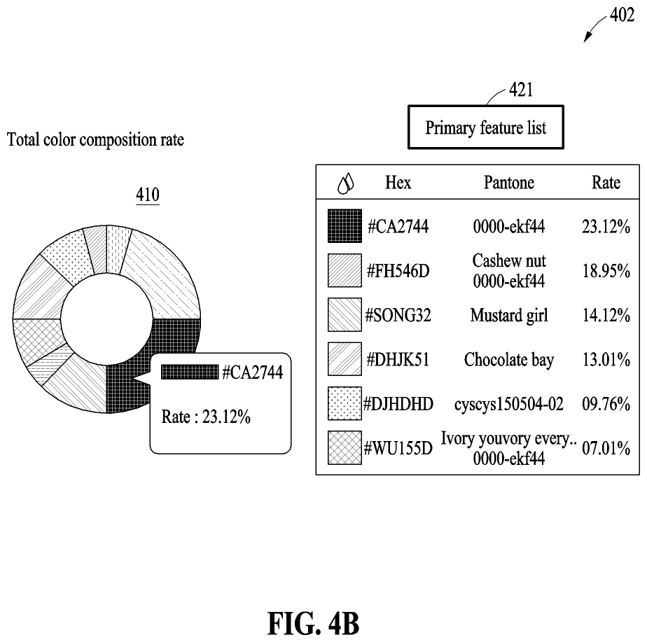

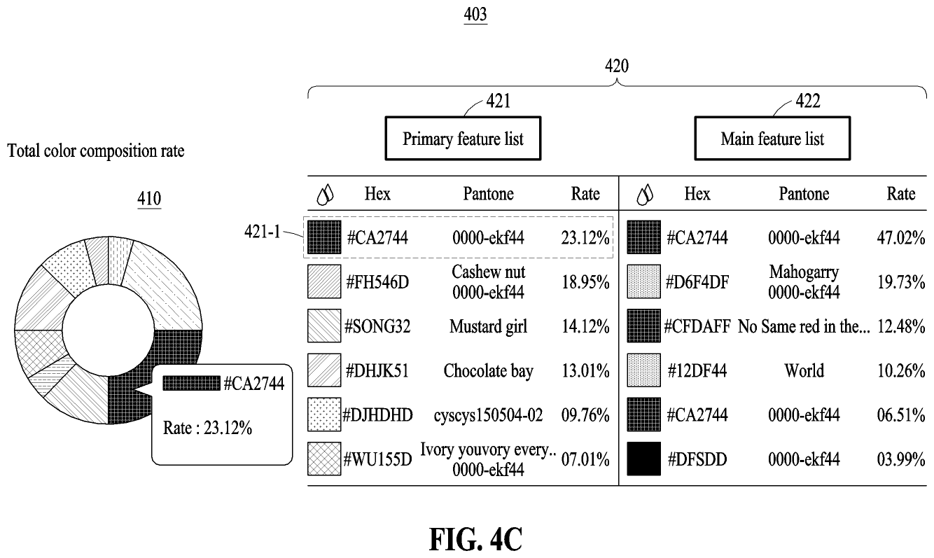

According to an embodiment, the processor 1030 may determine main features other than a primary feature in each of the plurality of groups as sub-features (e.g., main features) of the group. In operation 150, the processor 1030 may determine and provide statistics information related to the plurality of 3D garments based on primary features of the plurality of groups. According to an embodiment, the processor 1030 may match the sub-features to features secondary to a primary feature of a corresponding group and display the sub-features together with the primary features in response to receiving an input from a user. The method of providing statistics information on the sub-features is described in detail with reference to FIGS. 4C through 6 and 9E.

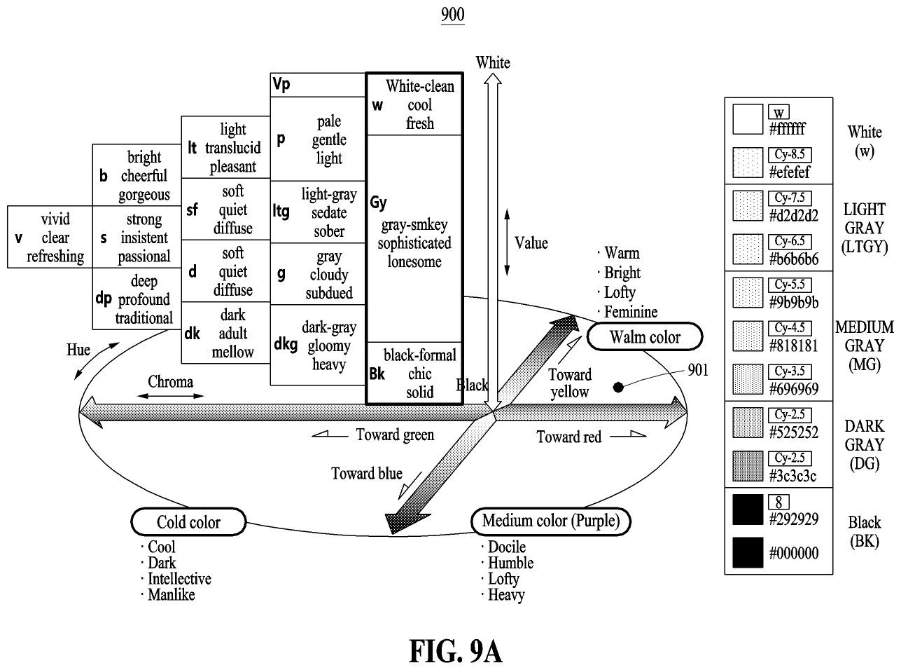

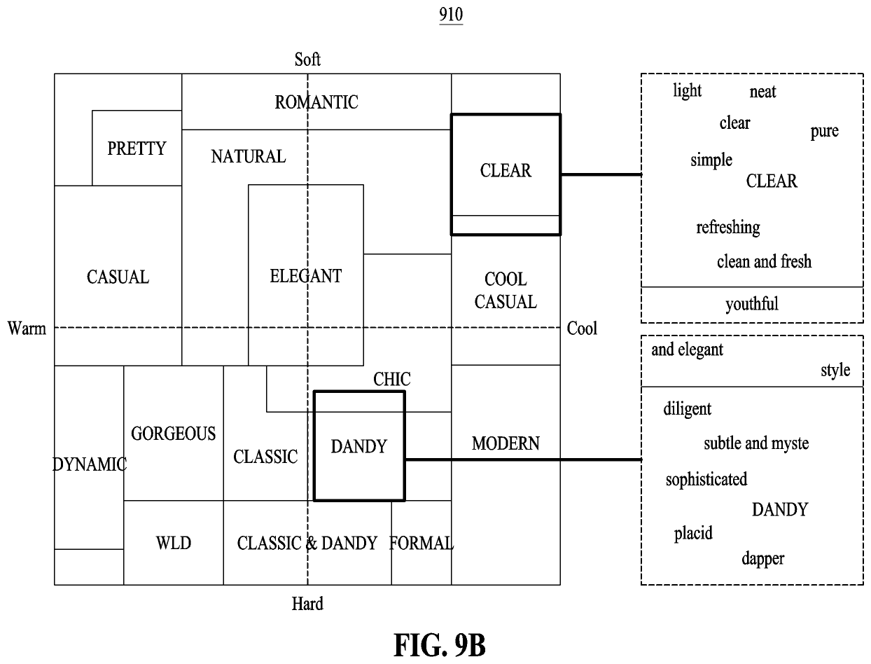

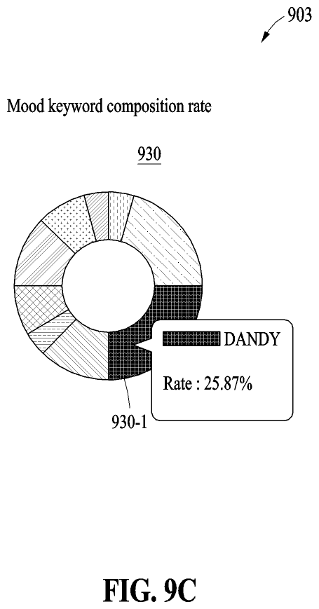

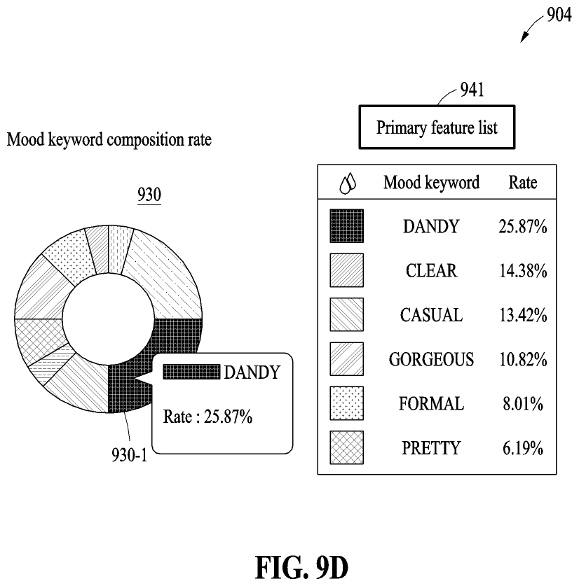

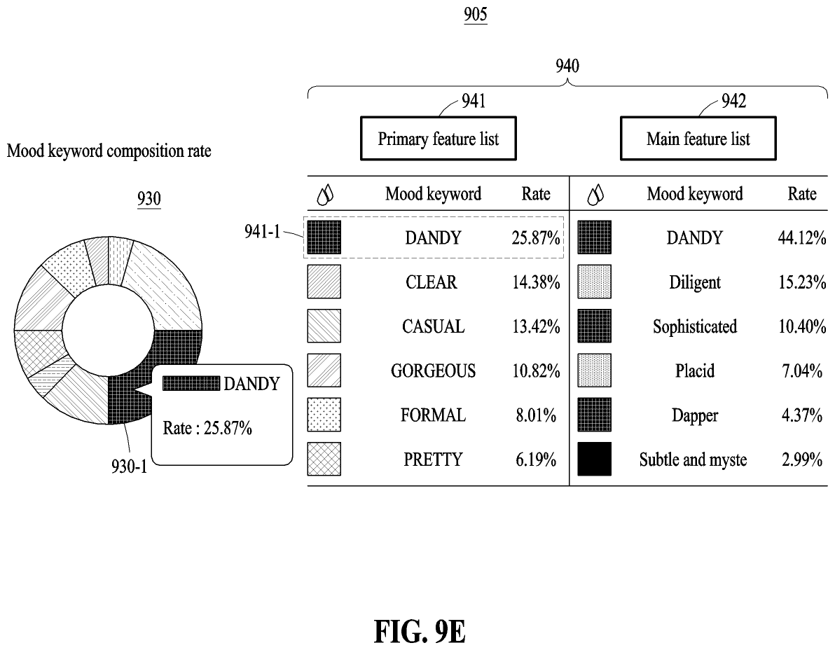

According to an embodiment, the processor 1030 may match the primary features to a predetermined mood keyword, and display the result of such matching. The mood keyword may be generated based on matching a keyword to a plurality of axes included in a space for representing a feature. A mood keyword is described in detail with reference to FIGS. 9A through 9E.

FIG. 2 is a conceptual diagram illustrating the grouping of main features of garments 210A through 210N, according to an embodiment. Referring to FIG. 2, the processor 1030 may extract features 210A through 210N from 3D garments 201A through 210N. Memory 1050 may store information on 3D garments 210A through 210N, including patterns that form 3D garments, and features of each of the patterns (e.g., color, type of fabric and glyphs). Garments 201A through 201N may be a subset of garments stored in memory 1050, and may have been filtered using various criteria such as time periods of designing, the names or identifications of designers, and keywords (e.g., summer, winter, classic, young) associated with season or styles. By parsing through the stored information on the 3D garments 201A through 201N of interest and tallying the frequencies or predominance of features in each of the 3D garments 201A through 201N, the processor 1030 extracts the main features 210A through 210N of the 3D garments 201A through 201N. From the extracted main features 210A through 210N, the processor 1030 generates groups 240A through 240M, and determines primary features R₁ through Rₘ based on actual frequency or predominance of the extracted features in the garments 210A through 210N.

A garment may have various features, and thus, the number of main features f₁¹, f₁², . . . f₁^{z} illustrated in FIG. 2 may vary depending on the data that the processor 1030 is programmed to extract. In this example, each of the garments 201A through 201N is assumed to have z number of main features, each feature corresponding to one of categories 1 through z. However, in practice, some garments may have fewer main features than others. In FIG. 2, f₁¹, f₁², . . . f₁^{z}, f₂¹, f₂², . . . f₂^{z}, fₙ¹, fₙ², . . . fₙ^{z} represent main features where subscripts indicate 3D garment numbers, while the superscripts indicate feature categories (e.g., color, type of fabric and glyphs). For example, f₁¹ may represent a main feature of 3D garment 201A which is a color, f₂¹ may represent a main feature of 3D garment 201B which is another color, f₁² may represent a main feature of 3D garment 201A which is a fabric type (e.g., wool), and f₂² may represent a main feature of 3D garment 201B which is another fabric type (e.g., polyester).

After main features 210A through 210N are extracted, the processor 1030 may determine a feature category for providing statistics information. For example, when the processor 1030 receives features related to color, texture, type of fabric, physical property of fabric, and garment style, the processor 1030 may determine only the color to be a feature of interest for providing statistics information. In this example, the processor 1030 may determine a color as a main feature of a 3D garment based on the frequency or predominance (e.g., ratio) of a surface area occupied by the color in the 3D garment. For example, in 3D garment 201A, when the color red occupies 70% of the surface area, and the color yellow occupies 30% of the surface area, the processor 1030 determines the color red to be main feature f₁¹ of 3D garment 201A. Similarly, in 3D garment 201B, when the color red occupies 70% of the surface area and the color yellow occupies 30% of the surface area, the processor 1030 determines the color red to be main feature f₂¹ of 3D garment 201B. In another example, in 3D garment 201N, when the color yellow occupies 70% of the surface area and the color red occupies 30% of the surface area, the processor 1030 determines the color yellow to be main feature fₙ¹ of 3D garment 201N.

When colors are used as the features of garments, the colors may be parameterized according to a color model or system (e.g., red green blue (RGB) value, HSV coordinate system, and PCCS tone map). Using the parameters or values of colors under the color model or system, the processor 1030 may group main features f₁¹, f₂¹, . . . , fₙ¹. An algorithm such as k-means clustering may be used for generating and classifying the main features f₁¹, f₂¹, . . . , fₙ¹. For example, if main feature f₁¹ and main feature f₂¹ are pure red and light red, respectively, and these two features may be assigned to the same group 240A according to a predetermined grouping scheme. On the other hand, if main feature fₙ¹ is yellow, it may be grouped into group 240M according to the predetermined grouping scheme (e.g., k-mean clustering).

The processor 1030 may determine reference values G₁, G₂, . . . , Gₘ for each group. A reference value in the context of colors may indicate a color coordinate of a standard or common color under a color model or system. For example, a pure red, a pure green, a pure blue are some of the standard or common colors, and their color coordinates correspond to reference values for these colors. In one or more embodiments, the processor 1030 may group main features f₁¹, f₂¹, . . . , f₁¹ based on their similarity to the reference values. The similarity of a main feature to a reference value may be determined based on the distance between color coordinates of the main feature and the reference value. For example, when reference value G₁ is a value representing a color coordinate of color red, f₁¹ and f₂¹ having color coordinates close to the color coordinate of reference value G₁ may be assigned to group 240A. Similarly, when reference value Gₘ is a color coordinate of color yellow, fₙ¹ having a color coordinate close to the color coordinate of reference value Gₘ may be assigned to group 240M. In this way, each of the main features may be assigned to a color group.

After the main features of different 3D garments are assigned to each group, the processor 1030 may determine primary features R₁, R₂, . . . , Rₘ of each group. The primary features R₁, R₂, . . . , Rₘ may be determined by weighted averaging the main features assigned to each of the groups 240A through 240M where the weights represent the frequencies or surface area ratios of the main features appearing in each of the groups. The primary features R₁, R₂, . . . , Rₘ of groups 240A through 240M may differ from reference values G₁, G₂, . . . , Gₘ of the same groups.

In an example with 100 garments and 100 main features, these main features may be categorized into 10 groups and a reference value G₁ of group 240A may be a color coordinate of pure red color. When there are 10 main features similar to the reference value G₁ included in group 240A and, among them, 5 main features represent a light red, 3 main features represent a dark red, and 2 main features represent a yellowish-red, the frequencies of the light red, the dark red and the yellowish-red are 5, 3, 2, respectively. Accordingly, the processor 1030 may assign these frequencies as weights to the color coordinates of the light red, the dark red and the yellowish-red and determined the weighted average of the coordinate as the color coordinate of primary feature R₁. The reference value G₁ of group 240A, on the other hand, would be the color coordinate of pure red color. The same process may be applied to different groups as well.

The processor 1030 may provide statistics information on primary features R₁, R₂, . . . , Rₘ for display or further processing, as described below in detail with reference to FIGS. 4A to 6.

FIG. 3 is a diagram illustrating a user interface screen displaying patterns of a 3D garment, according to an embodiment. Referring to FIG. 3, a 3D garment are displayed in two-dimensional (2D) space 310 and 3D space 330. The 3D garment may be composed of patterns 311, 313, 315, 317, 319 shown in the 2D space 310. The 3D garment may also be represented as being placed around or as being worn by an avatar 331 in the 3D space 330.

According to an embodiment, fabric characteristic data of patterns 311, 313, 315, 317, 319 and the surface areas of these patterns may be used for determining the main features of 3D garments. The fabric characteristic data and the surface areas of the patterns may be stored and available from memory 1050. For example, a garment illustrated in FIG. 3 may be 3D garment 201A. The pattern 311 may be yellow and take up 12% of the surface area of the garment, the pattern 313 may be red and take up 33% of the surface area of the garment, the pattern 315 may be yellow and take up 12% of the surface area of the garment, the pattern 317 may be red and take up 38% of the surfaced area of the garment, and the pattern 319 may be white and take up 5% of the surface area of the garment. Since the red takes up the highest percentage of the surface area (33%+38%=$71%), the processor 1030 may determine main feature f₁¹ of 3D garment 201A as a red color.

Although colors are described as main features, this is merely an example; and features other than colors may be used. For example, physical properties of fabric, the textures of fabric, garment styles, and glyphs may be used as features, and the main features may be determined based on the predominance or ratios of surface areas they take up in the 3D garment.

FIGS. 4A to 6 are diagrams illustrating user interface screens for providing statistics information on 3D garments, according to an embodiment. Referring to FIG. 4A to 4C, the processor 1030 may provide 3D garment content statistics information using a donut chart 410 and/or a list 420.

The 3D garment content statistics information may include statistics information on the ratio of the primary features R₁, R₂, . . . , Rₘ and/or statistics information on the ratios of main features in a corresponding group. Statistics information displayed using donut chart 410 indicates the ratios of the primary features R₁, R₂, . . . , Rₘ and/or the statistics information on the ratio of the main features f₁¹, f₂¹, . . . , fₙ¹ included in a group. For example, when the ratio of the primary features R₁, R₂, R₃ are 50% red, 30% yellow, and 20% blue, respectively, the areas occupied by red, yellow, and blue may be represented in the donut chart 410 according to their ratios. In addition, when the ratios of the main features f₁¹, f₂¹, . . . , fₙ¹ included in primary feature R₁ are 50% light red, 30% red, and 20% dark red, the areas occupied by light red, red, and dark red in the donut chart 410 may correspond to their ratios.

In FIGS. 4A through 4C, colors as features are indicated using hex color codes. In a hex color code, colors are represented using a six-digit code where the first two digits provide information on the amount of red in the color the second two digits provide information about the amount of green in the color, and the last two digits provide information about the amount of blue in the color. Each pairs of two digits may take a value from 0 to 255.

FIG. 4A illustrates a user interface screen 401 including the donut chart 410 that shows nine primary features where a red color with color hex code of CA2744 takes up the largest ratio of 23.12%. When the user selects this color by hovering a curser over part 410-1 of the donut chart 410 or clicking on part 410-1, color hex code of CA2744 and its ratio of (23.12%) are displayed, for example, in an overlapping manner on the user interface screen 401.

A user may request statistics information in the form of a list 421 listing a subset of the primary features as representative primary feature and their ratios from the donut chart 410. The processor 1030 may detect such request received from the user, and display a list of representative primary features in user interface 402, as shown in FIG. 4B. The request may be provided by the user as a double clicking on the donut chart 410 or invoking a menu and then selecting an item from the menu. In the example of FIG. 4B, nine primary features are shown in the donut chart 410 but only six are listed in the list 421 as representative primary features. The number of representative primary features to be displayed may be preset or be configured by a user.

In the list 421, color hex codes, pantone colors, and rates of the representative primary features are displayed in the user interface screen 402, as shown in FIG. 4B. Pantone color matching system is a standardized color reproduction system often used in printing and design industry. As shown in FIG. 4B, the ratios of the primary features R₁ (red with color hex #CA2744, pantone color 0000-ekf44), R₂ (pantone color cashew nut 0000-ekf44, color hex #FH546D), R₃ (pantone color mustard girl color, color hex #SONG32), R₄ (pantone color chocolate bay, color hex #DHJK51). R₅ (pantone color cyscys150504-02, color hex #DJHDHD), and R₆ (pantone color ivory 0000-ekf44, color hex #WU155D) in all garments of interest take up 23.12%, 18.95%, 14.12%, 13.01%, 9.76% and 7.01%, respectively, and their ratios are shown in the list 421.

FIG. 4C illustrates a user interface screen 403 that displays a main feature list 422 in addition to the primary feature list 421 and the donut chart 410, according to one embodiment. The user interface screen 403 may be displayed in response to receiving a user input indicating selection of one of the primary features 421-1 (color red with hex #CA2744) from a primary feature list 421. The user input for selecting the primary feature of interest may be, for example, clicking on an area of the screen showing one of the primary features. After receiving the user input, the processor 1030 may cause statistics information on the ratios of the main features in the group of the selected primary feature to be displayed in the form of the main feature list 422, as shown in FIG. 4C. As in FIG. 4B, only six primary features are shown in primary feature list 421 of FIG. 4C and only six representative main features are shown in main feature list 422 of FIG. 4C.

According to an embodiment, statistics information shown in the list 420 of FIG. 4C indicates ratios of the primary features R₁, R₂, . . . , Rₘ and/or the statistics information on the ratios of the main features f₁¹, f₂¹, . . . , f₁¹ assigned to a group. In addition, when the primary feature R₁ (red with color hex #CA2744) is selected by the user, the main feature list 422 shows main features (i.e., colors with hex #CA2755, D6F4DF, CFDAFF, 12DF44, CA2744 and DFSDD) that are associated with the primary feature R₁. Further, the ratios of the main features (i.e., 47.02%, 19.73%, 12.48%, 10.26%, 6.51%, and 3.99%, respectively) are shown as statistics information in the list 420.

According to an embodiment, the processor 1030 may link the statistics information displayed within the donut chart 410 and the statistics information shown in the list 420 to provide statistics information using the list 420 in response to receiving an input from the user (e.g., by selecting a color in the donut chart 410) and also provide statistics information (as shown in the list 420) using the donut chart 410 in response to receiving an input from the user from the statistics information.

According to an embodiment, the processor 1030 may cause statistics on 3D garments to be displayed, as illustrated in FIG. 4A through 6. The examples provided with reference to FIG. 4A to 4C are related to workspaces on an application and/or website that may be referred to as “project”, “assortment”, “workroom”, and the like. The processor 1030 may receive representative primary features and main features of a selected primary feature from a server connected to a database. In particular, the processor 1030 may provide various statistics information based on 3D garments, and more particularly, the processor 1030 may provide comparative statistics information between projects, assortments, and workrooms using features extracted from the above-mentioned project, assortment, and workroom. The terms “project”, “assortment”, “workroom”, and the like mentioned in the above-described example are names for some of workspaces on an application and/or web and may serve as a group, category, folder, and the like. Accordingly, hereinafter, a project, an assortment, a workroom, and the like, that includes 3D garment content are referred to as a group.

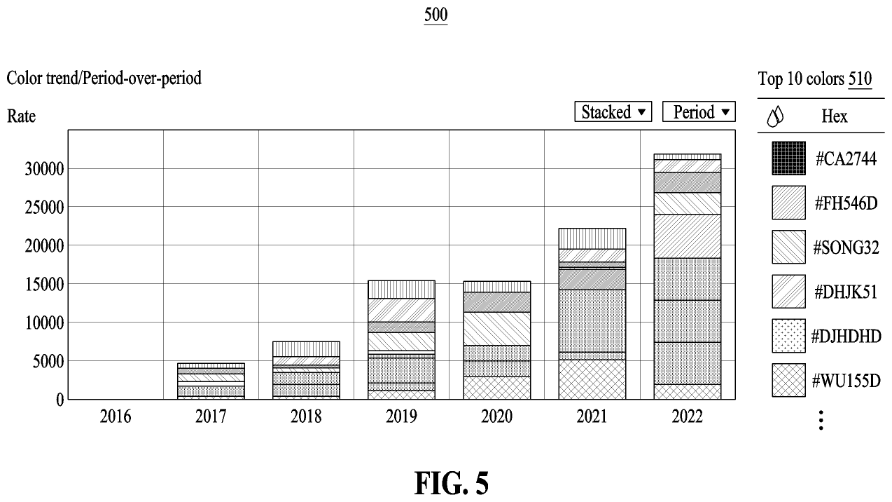

Referring to FIG. 5, the processor 1030 may provide statistics information related to 3D garment data using a bar chart 500. According to an embodiment, the processor 1030 may provide statistics information on current trending features by matching the primary features R₁, R₂, . . . , Rₘ extracted from 3D garments of prior release years. For example, the processor 1030 may select top 10 colors 510 by arranging the colors included in the primary features R₁, R₂, . . . , Rₘ in a descending order of frequency for a corresponding year and then provide the color usage rate using the bar chart 500. Upon receiving a user input, the processor 1030 may present statistic information in the form of the bar chart by itself as shown in FIG. 5 or along with a primary feature list 421 and/or a representative main feature list 422, as shown in FIG. 4B or FIG. 4C. Using such bar chart facilitates the user to understand the trends or changes of the primary features over multiple years.

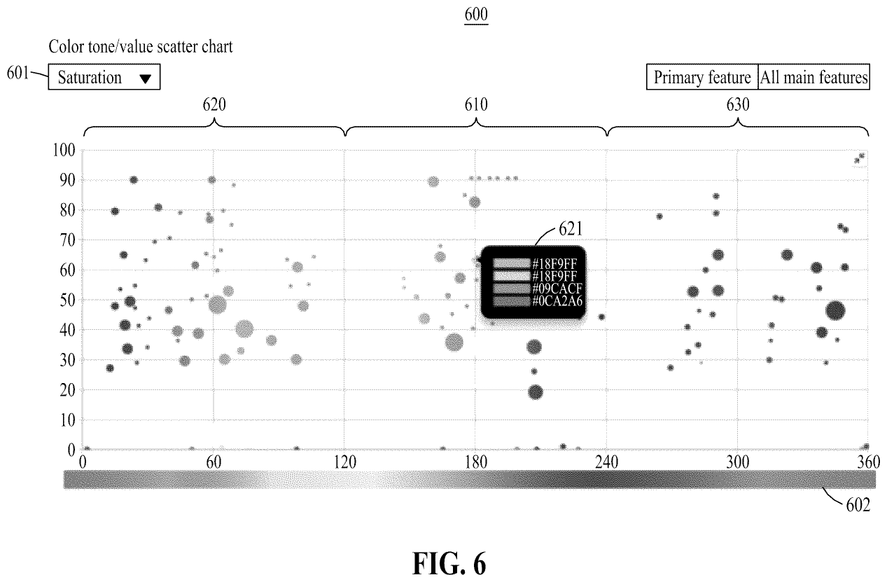

Referring to FIG. 6, the processor 1030 may provide statistics information related to 3D garments using a scatter chart 600, according to one embodiment. The processor 1030 may display the primary features R₁, R₂, . . . , Rₘ and their associated main features f₁¹, f₂¹, . . . , fₙ¹ distributed as dots on a chart along x-axis 602 (e.g., indicating hue color spectrum from 0 to 360 degrees) and along y-axis 601 (e.g., indicating saturation/brightness in percentage units). The sizes of dots may represent usage frequencies and surface area ratios of the primary features or main features. The feature dots may represent a plurality of groups in the form of colors and circles of the primary features R₁, R₂, . . . , Rₘ. For example, when the primary features R₁, R₂, . . . , Rₘ are displayed as distributed dots, the dots may be distributed in a yellow region 610, a blue region 620, and a red region 630 indicating a spectrum of hues. When a user selects (or hovers the cursor over) a dot within the blue region 620 (indicating primary features associated with blue colors), the processor 1030 may display clustered sub-color values (e.g., the main features f₁¹, f₂¹, . . . , fₙ¹) associated with the selected dot in a box 621 overlaid on the scatter chart 600. In the example of FIG. 6, four main features of the selected primary feature are displayed in the box 621.

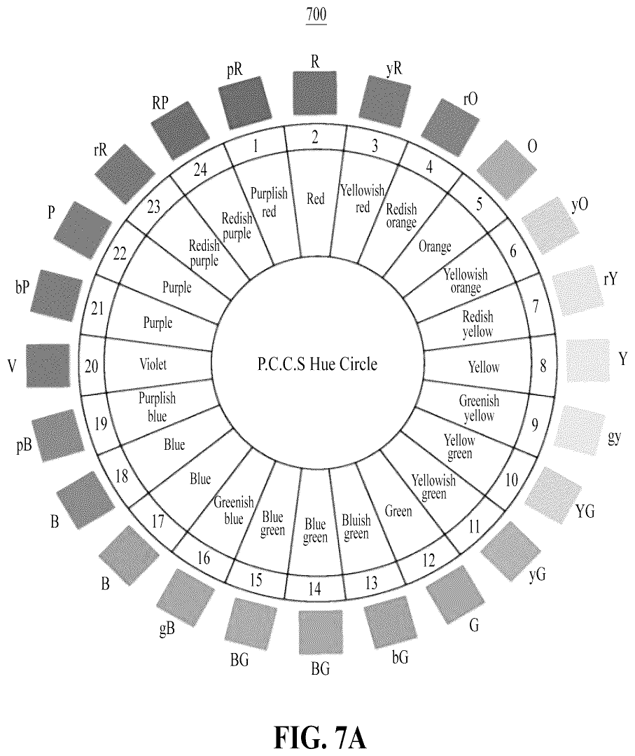

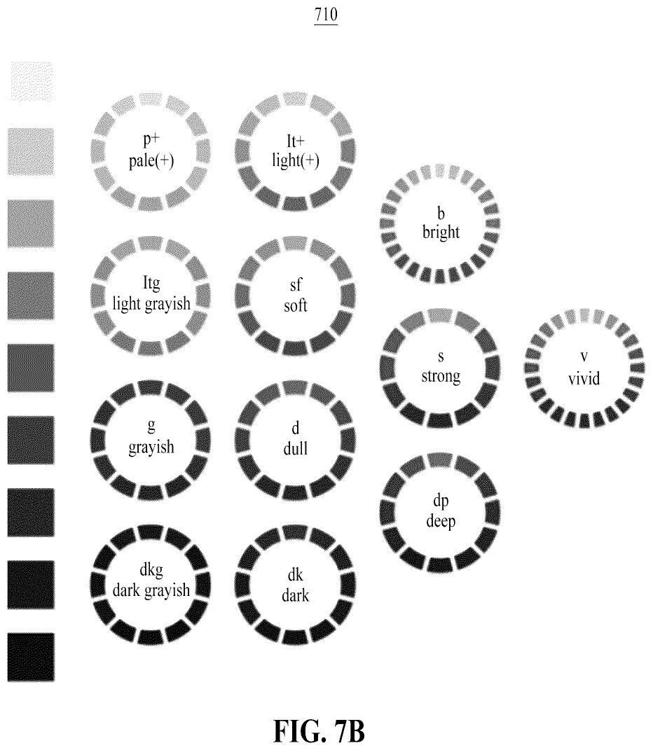

FIGS. 7A and 7B are diagrams illustrating PCCS tone mapping according to an embodiment. Each feature may include a color or a color and a texture. A color may be determined based on the base color of a fabric and at least one of the base color of the fabric and the base texture of the fabric. The color of the fabric may be defined by averaging the resulting color obtained by multiplying the base texture by the base color of the fabric. When only the gray text is used to calculate the color of the fabric, only the base color of the fabric may be extracted as the primary color.

Referring to FIG. 7A, the processor 1030 may map the main features f₁¹, f₂¹, . . . , fₙ¹ to a tone map based on a preset color system (e.g., a PCCS color system 700). The PCCS color system 700 is an example of a preset color system, and the preset color system may be expanded in various ways. In the PCCS color system 700, there are four psychological primary colors: red (R), yellow (Y), green (G), and blue (B). These four colors are arranged in a way that they are positioned opposite to each other. These four colors are divided in half to create eight colors and then, four more colors are added to make the colors perceptually equidistant, resulting in 12 colors. These 12 colors are further divided to form 24 colors. Color symbols are represented by connecting numbers and letters with a colon “:”. Color symbols are denoted using the initial letters of color names in English, preceded by the lowercase initial letters of adjectives. The sequence begins with red represented as 1:pR, followed by 2:R, 3:yR, 4:rO, and 5:0, and continues up to 22:P, 23:rP, and 24:RP.

In the PCCS color system 700, the lightness standard divides the vertical axis between black and white to create visually uniform spacings. The vertical axis between black, white is divided into halves, and each half is further divided into halves to create five levels of lightness. Each of the five levels is divided into halves, resulting in nine levels of lightness. Finally, each of the nine levels is divided into halves, creating a total of 17 levels of lightness. Lightness symbols are based on the Munsell system's lightness scale. According to this scale, white is given a value of 9.5, black is given a value of 1.5, and the range between black and white is divided into 17 levels, each separated by a spacing of 0.5 level.

The saturation standard is determined by selecting a reference color for each hue based on the perceptually vivid, highly saturated color range that is actually obtained from color materials. At the lightness level, which serves as the reference color of each hue, the range between the reference color and the lowest chromatic color is divided into nine equidistant levels. These levels are represented as 1s, 2s, 3s, . . . , 9s with the addition of a saturation symbol “s” to differentiate this system from others. Unlike Munsell system, absolute saturation values apply to this system. Thus, this system represents all colors with an absolute scale of 9 levels without perceptual equidistance.

Referring to FIG. 7B, tone may be considered to be a complex concept of lightness and saturation, describing color state differences. Color state differences refer to the degree of variation in colors, even when the colors belong to the same hue, indicating differences in factors like brightness, darkness, intensity, faintness, vividness, paleness, depth, and shallowness.

A PCCS tone map 710 is divided into 12 categories: pale, light, bright, vivid, strong, soft, dull, deep, dark, light grayish, grayish, and dark grayish. Categorizing colors into 12 tones for each color may create groups of colors that share the same tone. Within each group, the colors may be clearly recognized as having a common tone, even though there may be variations in lightness among the colors. In tones with low saturation, such as light grayish and dark grayish tones, there may not be significant differences in lightness due to color. However, in a high-saturation vivid tone group, significant differences in lightness may be observed. Moreover, even if colors belong to the same hue, different tones may create different emotional effects, while colors from different hues but the same tone may create the same emotional effect. Therefore, tone may help convey the impression of a color, inspire color combinations, or provide a more accurate way to describe color names.

The processor 1030 may cluster and group the main features f₁¹, f₂¹, . . . , fₙ¹ using the PCCS color system 700 and the PCCS tone map 710. For example, main feature f₁¹ (e.g., red) may be mapped to strong red (R) in the PCCS tone map 710. Main feature two f₂¹ (e.g., light red) may be mapped to soft R in the PCCS tone map 710. By repeating the above-described process, the main features f₁¹, f₂¹, . . . , fₙ¹ may be clustered and grouped.

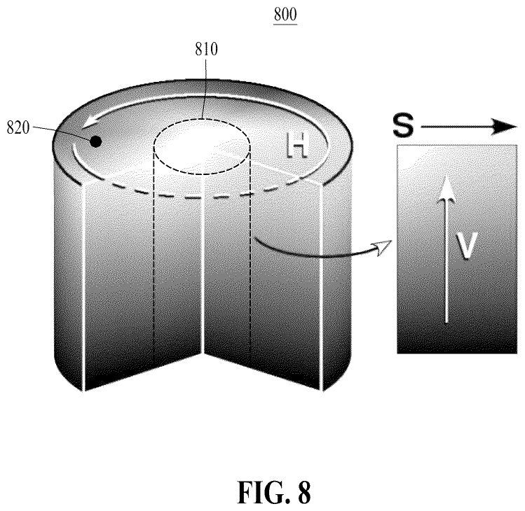

FIG. 8 is a diagram illustrating a hue, saturation, value (HSV) coordinate system according to an embodiment. The HSV color space or HSV model is one way to represent colors and for organizing the colors. The HSV space, HSV color space, or HSV model may map a predetermined color to coordinates to designate the color using coordinates of three axes representing hue, saturation, and value. For example, these three axes may be the x, y, and z axes, or alternatively, the x, y, and angular axes. The HSV space, HSV color space, HSV model, and the like, described herein, are only examples of a color space in which a predetermined color is represented.

Referring to FIG. 8, the processor 1030 may identify the main features f₁¹, f₂¹, . . . , fₙ¹ in a color space (e.g., an HSV space 800). For example, the HSV space 800 may be represented by the H-axis, S-axis, and V-axis. The processor 1030 may classify the main features f₁¹, f₂¹, . . . , fₙ¹ into chromatic colors and achromatic colors based on an S-axis threshold value 810 set in the HSV space 800. Chromatic and achromatic colors may be determined by saturation, with colors closer to the central line of the cylinder more likely to be achromatic. For example, the S-axis threshold value 810 may be a random point along the saturation axis (hereinafter, the “S-axis”), which is represented in the circumferential direction of the cylinder from the central line of the cylinder in the HSV space 800. Therefore, when applying the S-axis threshold value 810 to the H-axis and V-axis, the S-axis threshold value 810 may be represented as the circumference of a small cylinder outlined by dashed lines within the HSV space 800, which is represented as a cylinder. For example, when main feature one f₁¹ is red, main feature one may be located at R 820. Color 820 is located at a point on the S-axis that exceeds the S-axis threshold value 810, and thus, the processor 1030 may determine color 820 to be a chromatic color. In this way, the processor 1030 may classify main features based on the S-axis threshold value 810 set in the color space. A threshold value may be set for each of the H-axis, S-axis, and V-axis in the color space. Therefore, the processor 1030 may classify the main features f₁¹, f₂¹, . . . , fₙ¹ by color by setting an H-axis threshold value or classify the main features f₁¹, f₂¹, . . . , fₙ¹ by lightness by setting a V-axis threshold value. The representation of an HSV space is not limited to a cylinder as described herein, and various shapes, such as a cone shape, may be used to represent an HSV space.

FIGS. 9A and 9B are diagrams illustrating a mood keyword according to an embodiment. Referring to FIGS. 9A and 9B, the processor 1030 may match the main features f₁¹, f₂¹, . . . , fₙ¹ mapped to the PCCS tone map 710 and the primary features R₁, R₂, . . . , Rₘ to mood keywords. The processor 1030 may match the main features f₁¹, f₂¹, . . . , fₙ¹ and the primary features R₁, R₂, . . . , Rₘ to mood keywords using a 3D mood keyword map 900 and/or 2D mood keyword map 910. For example, main feature f₁¹ indicates red color but may be matched to Warm Red in the 3D mood keyword map.

Referring to FIG. 9A, mood keywords may be expressed in terms of a predetermined 3D keyword map 900. Alternatively, as shown in FIG. 9B, mood keywords may also be expressed in terms of 2D mood keyword map 910. The processor 1030 may select one of these predetermined methods and map the colors to the mood keywords. For example, the processor 1030 may use a large language model (LLM) and map the colors to the mood keywords. Using the 2D mood keyword map 910, for example, statistics information may be provided using the user interface screens as shown in FIGS. 9C through 9E.

FIG. 9C illustrates a user interface screen 903 that provides statistics information according to donut chart 930. Specifically, the processor 1030 may display the extracted colors from garments and their mapped mod keywords into the form of the donut chart 930. The mapping between colors and the mood keywords may be stored in a database of a server. The mapping between the colors and the mood keywords are not always one-to-one correlation, and multiple colors may be mapped to a single mood keyword.

When the user hovers a cursor over part 930-1 of the donut chart 930 or clicks on the part 930-1, a ratio of the color (e.g., 25.87%) as a primary feature and its mapped mood keyword (e.g., DANDY) may be displayed on the user interface screen 903.

A user may prompt displaying of a list of primary feature list 941 listing all or a subset of the primary features. Taking the example of FIG. 9D, six representative colors (features), their mapped mood keywords (e.g., DANDY, CLEAR, CASUAL, GORGEOUS, FORMAL AND PRETTY) and their ratios may be displayed when the user requests statistics information be presented in the form of the feature list 941. The user requests for the statistics information may be in the form of double clicking on the donut chart 930 or selecting an item from a menu).

FIG. 9E is a diagram illustrating a user interface screen 905 that shows a main feature list 942 listing mood keywords mapped to the main features (color) and their ratios in response to selecting a primary feature, according to one embodiment. In the example of FIG. 9E, the user may select the first color mapped to the mood keyword “DANDY” by clicking part 941-1. By selecting the color (i.e., a primary feature), all or a subset of the main features associated with the selected color may be shown in the main feature list 942. In this example, six top main features associated with the primary feature color (mapped to the mood keyword “DANDY”) are listed in the main feature list 942. The remaining main features associated with the same primary feature color are not listed in the main feature list 942.

According to an embodiment, mood keywords may be set differently according to how people from different countries, cultural backgrounds, or lifestyles perceive the same gamut of color differently. For example, when statistics information is produced for one country, the processor 1030 may provide mood keywords matched to the perception of colors in that country. Therefore, the processor 1030 may employ a mood keyword map that may be localized to different countries. In another example, the processor 1030 may employ a mood keyword map based on various personal traits, such as age, gender, and the like. Accordingly, the processor 1030 may provide different mood keywords for each user. In another example, the processor 1030 may employ a mood keyword map that combines localization along with the personalization. Such different mapping configurations may be set by users manually or be preset and stored in memory 1050 for loading. Accordingly, a user presented with the statistics information may conveniently and accurately determine the demand for certain types or styles of garments.

According to an embodiment, the processor 1030 may provide statistics information related to a plurality of 3D garments in a manner suitable to the user. For example, the processor 1030 may provide statistics information related to different types of garments. In this example, a first type of garments may be garments to be worn in the spring/summer (S/S) season may be set as a first group, and a second type of garments may be garments to be worn in the fall/winter (F/W) season may be set as a second group. The processor 1030 may provide statistics information related to 3D garments in response to the user's selection of a garment within each group. In another example, the processor 1030 may provide comparative statistics information between individual groups. In other words, the processor 1030 may provide statistics information related to a garment data in the first group and statistics information related to another garment in the second group. The processor 1030 may compare the statistics information related to the garments of both groups, enabling the user to readily discern commonalities and differences among the statistics information associated with the two groups.

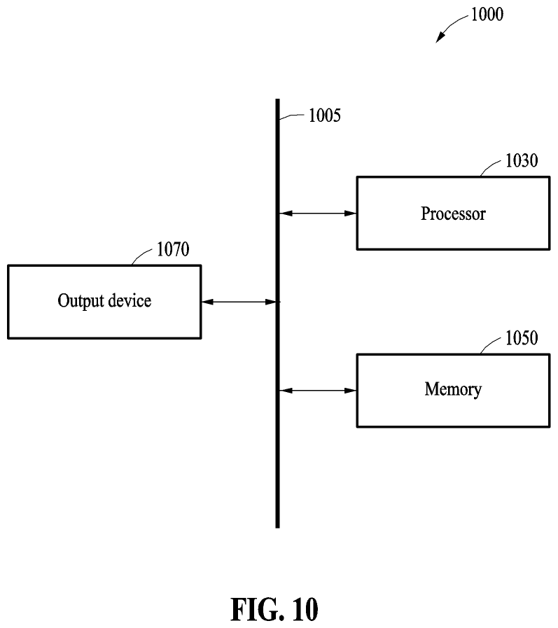

FIG. 10 is a block diagram of an electronic device according to an embodiment. Referring to FIG. 10, an electronic device 1000 may include the processor 1030, a memory 1050, and an output device 1070 (e.g., a display). The processor 1030, the memory 1050, and the output device 1070 may be connected to each other via a communication bus 1005.

The output device 1070 may display statistics information of 3D garments as processed by the processor 1030.

The memory 1050 may store a 3D garment transformed by the processor 1030. Furthermore, the memory 1050 may store various pieces of information generated by the processor 1030 described above. Also, the memory 1050 may store various pieces of data, programs, and the like. The memory 1050 may include a volatile memory or a non-volatile memory. The memory 1050 may include a high-capacity storage medium such as a hard disk to store a various pieces of data.

Also, the processor 1030 may perform at least one of the methods described with reference to FIGS. 1 to 9 or an algorithm corresponding to at least one of the methods. The processor 1030 may be a data processing device implemented by hardware including a circuit having a physical structure to perform desired operations. The desired operations may include, for example, code or instructions in a program. The processor 1030 may be implemented as, for example, a central processing unit (CPU), a graphics processing unit (GPU), or a neural network processing unit (NPU). The electronic device 1000 implemented as hardware may include, for example, a microprocessor, a CPU, a processor core, a multi-core processor, a multiprocessor, an application-specific integrated circuit (ASIC), and a field-programmable gate array (FPGA).

The processor 1030 may execute a program and control the electronic device 1000. Code of the program executed by the processor 1030 may be stored in the memory 1050.

The embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, an FPGA, a programmable logic unit (PLU), a microprocessor, or any other device capable of responding to and executing instructions in a defined manner. The processing device may run an OS and one or more software applications that run on the OS. The processing device may also access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as, parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method of providing statistics information, the method comprising:
extracting main features of a category for garments by analyzing stored information on the garments, each of the main features representing a predominant feature of the category in each of the garments;
assigning the main features of the garments to groups, each of the groups associated with a primary feature of the category that is shared across garments in each of the groups;
processing information on the garments according to the groups to generate statistics information on primary features; and
presenting the generated statistics information including identifications of the primary features.

2. The method of claim 1, further comprising selecting the garments for extracting the main features according to one or more criteria from stored garments.

3. The method of claim 2, wherein the one or more criteria comprises at least one of time periods of designing the garments, identifications of designers of the garments, and keywords.

4. The method of claim 1, wherein assigning the main features of the garments comprises:
determining a reference value for each of the groups, the reference value indicating a standard or common feature;
determining similarity of the main features and reference values of the groups; and
assigning the main features to the groups according to the determined similarity.

5. The method of claim 1, wherein the generated statistics information comprises ratios of the primary features occupied in the garments.

6. The method of claim 1, wherein the category is one of colors, textures of fabric, garment styles, or glyphs on the garments.

7. The method of claim 1, further comprising, responsive to receiving selection of one of the primary features, presenting statistics information on main features assigned to a group corresponding to the selected primary feature.

8. The method of claim 7, wherein the presented statistics information on the main features includes ratios of at least a subset of the main features assigned to the group.

9. The method of claim 1, further comprising presenting mood keywords corresponding to the primary features.

10. The method of claim 9, further comprising:
storing mapping between features of the category and the mood keywords; and
determining the mood keywords to be presented according to the stored mapping.

11. A non-transitory computer-readable storage medium storing instructions that, when executed by a processor, cause one or more processors to:
extract main features of a category for garments by analyzing stored information on the garments, each of the main features representing a predominant feature of the category in each of the garments;
assign the main features of the garments to groups, each of the groups associated with a primary feature of the category that is shared across garments in each of the groups;
process information on the garments according to the groups to generate statistics information on primary features; and
present the generated statistics information including identifications of the primary features.

12. The non-transitory computer-readable storage medium of claim 11, further storing instruction that cause the one or more processors to select the garments for extracting the main features according to one or more criteria.

13. The non-transitory computer-readable storage medium of claim 11, wherein instructions that cause the one or more processors to assign the main features of the garments comprises instructions that cause the one or more processors to:
determine a reference value for each of the groups, the reference value indicating a standard or common feature;
determine similarity of the main features and reference values of the groups; and
assign the main features to the groups according to the determined similarity.

14. The non-transitory computer-readable storage medium of claim 11, further storing instructions that cause the one or more processors to, responsive to receiving selection of one of the primary features, present statistics information on main features assigned to a group corresponding to the selected primary feature.

15. The non-transitory computer-readable storage medium of claim 11, further storing instructions that cause the one or more processors to present mood keywords corresponding to the primary features.

16. The non-transitory computer-readable storage medium of claim 15, further storing instructions that cause the one or more processors to:
store mapping between features of the category and the mood keywords; and
determine the mood keywords to be presented according to the stored mapping.

17. A computing device comprising:
one or more processors; and
a memory storing instructions thereon, the instructions when executed by the one or more processors cause the one or more processors to:
extract main features of a category for garments by analyzing stored information on the garments, each of the main features representing a predominant feature of the category in each of the garments;
assign the main features of the garments to groups, each of the groups associated with a primary feature of the category that is shared across garments in each of the groups;
process information on the garments according to the groups to generate statistics information on primary features; and
present the generated statistics information including identifications of the primary features.

18. The computing device of claim 17, wherein the instructions cause the one or more processors to select the garments for extracting the main features according to one or more criteria.

19. The computing device of claim 17, wherein instructions that cause the one or more processors to assign the main features of the garments comprises instructions that cause the one or more processors to:
determine a reference value for each of the groups, the reference value indicating a standard or common feature;
determine similarity of the main features and reference values of the groups; and
assign the main features to the groups according to the determined similarity.

20. The computing device of claim 17, further storing instructions that cause the one or more processors to present mood keywords corresponding to the primary features.
